(19) United States
(12) Patent Application Publication
(10) Pub. No.: US 2004/0182260 A1
(43) Pub. Date: Sep. 23, 2004

(54) Rendering screw presses and methods of operating the same

(76) Inventor: David Miles, (US)

Correspondence Address: MYERS BIGEL SIBLEY & SAJOVEC, PO BOX 37428, RALEIGH, NC, 27627, US

(21) Appl. No.: 10/624,441

(22) Filed: Jul. 22, 2003

(30) Foreign Application Priority Data
Mar. 19, 2003 (GB) 0306283.3

(51) Int. Cl. B30B 9/02; A47J 19/02; B30B 9/12; B30B 9/14; B30B 9/16; B30B 9/18

(52) U.S. Cl. 100/37; 100/104

(57) ABSTRACT

Liquids are extracted from a process material by compressing the process material; decompressing and mixing the process material, and then recompressing the process material in a mechanical screw press.

### RELATED APPLICATION

This application claims priority to Great Britain Patent Application No. GB 0306283.3, filed Mar. 19, 2003, the disclosure of which is hereby incorporated herein by reference.

### FIELD OF THE INVENTION

This invention relates to a novel method of extracting fluids from oil or fat bearing materials, such as rendered bone material and to novel apparatus related thereto, e.g. a mechanical screw press incorporating a worm assembly.

### BACKGROUND OF THE INVENTION

A number of screw press manufacturers design continuous mechanical screw presses for use in the rendering industry, which incorporate a worm assembly rotatably driven by a drive shaft. Conventionally, presses comprise a known worm assembly rotating within a drained “Cage” or tunnel from which oils and/or fats are expelled, e.g. radially.

In use, pre-cooked process material enters the press at a feed end of the press and is subjected to continuously increasing pressure until it is discharged as ‘cake’ at a discharge end of the press, for example, via an hydraulically-adjustable annular choke assembly. Derivatives of the basic design, incorporating similar worm assemblies and/or similar choke assemblies, are also known.

De Smet Rosedowns (DSR) are UK-based manufacturers of screw presses and spare parts for both the vegetable oil extraction industry and for the rendering industry. Over the years, DSR has been at the forefront of design innovation for improving the performance of screw presses in terms of increased throughput, lower residuals and reduced power consumption. Such improvements rely on an intimate knowledge of press operation and on the ability to predict changing pressure and flow conditions within a press. An important aspect of DSR business is the design and manufacture of performance enhancing worm assemblies for fitting to presses originally manufactured by competitors.

Recent developments in screw presses have tended towards addressing the wear that occurs on the flights of worm assemblies. Thus, for example, European Patent application No. 0 540 222 describes the use of a bi-metallic worm assembly. However, it should be noted that the design of the worm assembly itself is conventional.

Mechanical screw presses find utility in a number of areas, including extraction of oils from seeds and/or nuts and extraction of fats from animal by-products. It will be understood that reference hereinafter to ‘process material’ should be construed generally as meaning products used in the Rendering Industry, such as animal carcasses.

Recent developments in the extraction of oil from seeds, using mechanical screw presses, have utilised a novel multi-stage approach of sequentially pressing, mixing and pressing the seeds. Whilst this method has been found to be advantageous in seed presses, it has hitherto been considered unsuitable for use in rendering screw presses, due, inter alia, to the risk of clogging of the mixing portion of the worm assembly in the screw press.

### SUMMARY OF THE INVENTION

We have now surprisingly found that, not only can conventional screw presses be adapted to include a mixing region in the worm assembly, but, in use, this results in a significantly improved yield of oil/fat from the mechanical press. Recently, a DSR conversion of a Dupps press has yielded dramatic improvements in throughput (around 50%) with no significant deterioration in residual fat levels. Furthermore, no increase in power consumption or wear of critical parts was observed. (measured per ton of material processed) Indeed, in some instances power consumption was reduced.

Thus, according to the invention we provide a method of extracting liquids from process material which comprises the sequential steps of compressing the process material; decompressing and mixing the process material; and further re-compressing the process material in a mechanical screw press.

The step of decompressing and mixing may occur separately, simultaneously or sequentially. In one embodiment described herein decompression and mixing steps may occur separately. In such a case it is preferred that the decompression substantially precedes the mixing. However, in the most preferred embodiment and the embodiment hereinafter described in the examples, the decompression and mixing occur simultaneously.

The decompression/mixing process can be carried out using a mixer assembly as hereinafter described. However, preferably the decompression/mixing process can be carried out using a compression mixer. A compression mixer, which may also be referred to as a Hump mixer, is especially advantageous in that, inter alia, it will produce an extra compression just prior to the decompression and mixing zone. Thus, it will be understood that a compressor mixer may comprise a frusto conical (compressor) member and an optionally integral mixing member.

Extraction of fat in, for example, a Dupps press using the original assembly (FIG. 1) is by a process of continuously increasing the pressure applied to the process material as it moves from the intake to the discharge end of the press. However, there comes a point at which the pressure required to expel further fat is disproportionately high. The DSR worm assembly (FIG. 2) relies on the principle analogous to that involved in wringing water from a wet towel; beyond a certain point no further water can be removed by sustained wringing. However, if the towel is unfolded and wrung out again then more water can be removed. In a screw press, this effect can be achieved by introduction of one or more humps and one or more mixers into the assembly. It is within the scope of the method of the present invention for the decompression/mixing to occur by use of a mixer, e.g. fitted to the worm shaft. However, preferably the mixer comprises of the combination of the Hump and Mixer. Pressure is built up initially by the combined action of helical worms and a tapered distance piece (or hump) and some fat is expelled. Pressure is then allowed to fall as the process material enters a mixing region, after which pressure is reapplied and more fat is expelled.

Furthermore, a measure of the compression can be described in terms of volume reduction (see FIGS. 3a and 3b). Thus, a conventionally known mechanical screw press (FIG. 3a) will show a substantially constant volume reduction of the compressed material along the length of the worm assembly. This contrasts with the volume reduction observed with the method of the present invention. Due to the incorporation of a compression/mixing stage mounted in the worm assembly, the volume reduction is not constant. Indeed, at the point in the assembly where the mixer is positioned, an increase in the volume of the compressed material is observed. This may be an important feature of the present invention. The effect of these design modifications can be seen by comparing the Volume Reduction Curves for the two worm assemblies, from which the differences in pressure build-up along the press can be seen (FIGS. 3a & 3b).

Thus, according to an alternative aspect of the present invention we provide a method of extracting liquids from the process material which comprises the sequential steps of reducing the volume of the process material; increasing the volume of the process material; and reducing the volume of the process material in a mechanical screw press.

During trials of a DSR conversion of a Dupps press, it was also found that a further advantage was that there was no necessity to use the hydraulic choke to regulate pressure and there was much reduced burning and smoking of the residual cake. The performance improvements observed resulted from a fundamental analysis of the existing worm assembly and the judicious application of modifications to improve the flow and mixing of the process material. The pressure and/or speed of rotation of the worm, spacing between the worm and/or flights and the tunnel may be conventionally known per se. Thus, the press may optionally be provided with a choke, e.g. at the discharge end of the press. However, it is a particular advantage of the method of the invention that in many systems a choke is deemed unnecessary.

The method of the invention is advantageous in that, inter alia, an increased throughput of material is achieved. This increased throughput thus results in an increase in production rate with no detriment to the product quality.

The position of the compression mixer may vary according to the size and nature of the worm assembly, the material to be compressed, etc. However, in a preferred embodiment of the method of the invention, when the assembly is provided with a single compression mixer, the compression mixer is positioned close to the middle of the worm assembly, for example, at a position of between 40% and 70% of the length of the assembly, and preferably at between 50 and 65% of the length of the worm assembly, as measured from the feed inlet end. However, when the assembly is provided with more than one compression mixer, e.g. two compression mixers, they may be substantially evenly spaced along the length of the worm assembly. Thus, a first compression mixer may be positioned between 25 to 40% of the length of the worm assembly and a second compression mixer may be positioned between 60 and 80% of the length of the worm assembly.

The use of compression mixers in the extraction of oil from seeds etc is known.

Generally, the compression mixer comprises a tapered compression region and a mixer region. However, in the extraction of liquids from the process material, conventional mixers in the form of devices incorporating radially projecting elements e.g. in the form of a toothed disc, are unsuitable, due inter alia, to snagging, etc. Thus, the mixer may comprises an element adapted to disrupt the flow of material, this may be a multirecessed cog, a toothed disc, or any combination of the aforesaid. However, in the method of the invention a preferred mixer comprises a multirecessed cog.

In one embodiment of the invention, the method may also include a temperature control element to facilitate flow. Thus, warming or heating the system may facilitate flow of e.g. high melting fats at start up and, optionally, cooling may be used later in the process, thus further optimising fat extraction.

According to a further aspect of the invention, we provide a mechanical screw press comprising a worm assembly adapted to extract liquids from the process material by the sequential steps of compressing; decompressing and mixing; and recompressing the process material in a mechanical screw press.

According to a further aspect of the invention, we provide a mechanical screw press comprising a worm assembly provided with a plurality of circumferential flights and a compression mixer stage along the length of the worm assembly.

In this further aspect of the invention, the mechanical screw press may include a plurality of compression mixer stages.

Alternatively, we provide a mechanical screw press comprising a worm assembly adapted to extract liquids from process material by the sequential steps of volume reduction, volume increase and volume reduction.

The mechanical screw press of the invention comprises a worm assembly wherein the assembly is provided with at least one mixer region. Preferentially the mixer region is a combined compression/mixing region, e.g. a compression mixer as hereinbefore described.

We also provide the use of a worm assembly as hereinbefore described.

The use of the compression mixer in process material compression is also novel per se. Therefore according to a further aspect of the invention we provide the use of a compression mixer as hereinbefore described in the extraction of liquids from process material.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a cross-section view of a conventional Dupps screw press;

FIG. 2 is a cross-section view of a screw press in accordance with some embodiments of the present invention;

FIG. 3A is a graph of a volume reduction curve for a conventional Dupps screw press; and

FIG. 3B is a graph of a volume reduction curve for a screw press in accordance with some embodiments of the present invention.

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

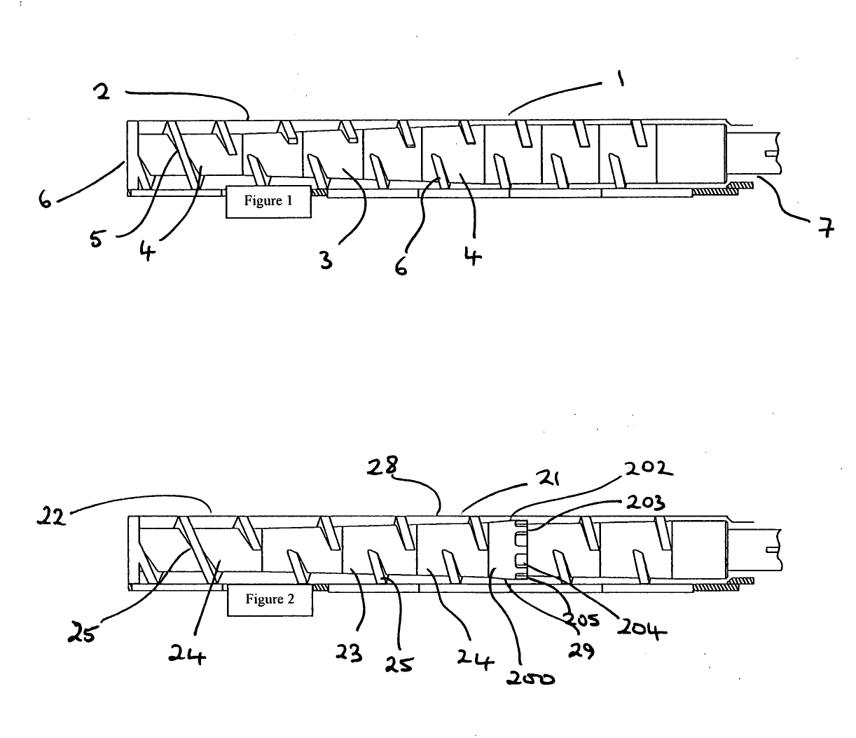

The invention will now be described by way of example only and with reference to the accompanying drawings in which FIG. 1 is a representation of a Dupps screw press of the prior art;

FIG. 2 is a representation of a modified Dupps screw press provided with a compression mixer region; and

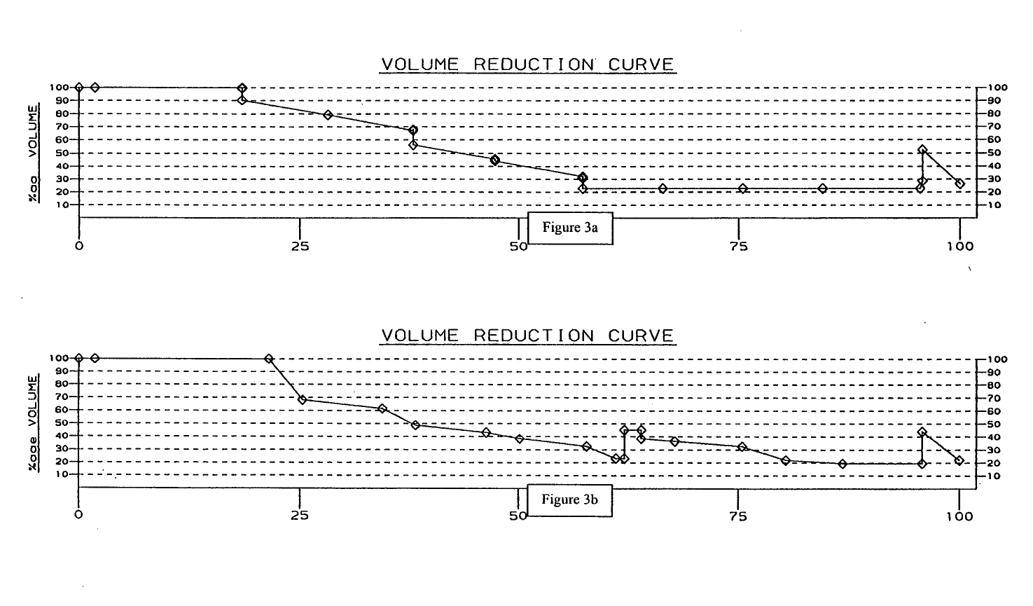

FIGS. 3a and 3b are graphical representations of volume reduction curves produced from a prior art Dupps Screw press and a modified Dupps screw press.

Referring to FIG. 1, a prior art arrangement (1) comprises a Cage (2) and worm assembly (3). The worm assembly (3) comprises a plurality of modular units (4) each fitted with an external flight (5). The press comprises a feed inlet end (6) and a discharge end (7).

Referring to FIG. 2, the novel Arrangement (21) comprises a Cage (22) and worm assembly (23). The assembly (23) comprises a plurality of modular units (24) each fitted with an external flight (25). Close to the middle (28) of the worm assembly (23) a compressor/mixer (29) is positioned. The compressor mixer (29) comprises a frusto conical member (200), which is shaped to compress the process material (201) (not shown). The larger diameter end (202) of the frusto conical member (200) of the frusto conical member (200) is provided with a mixer (203). The mixer (203) is itself made up of a plurality of circumferential recesses (204) around the periphery (205) of the mixer.

In use, process material passes along the worm assembly due to the action of the flights. When the material reaches the compression mixer, the process material is further compressed and then allowed to expand in volume and mixed.

That which is claimed is:

1. A method of extracting liquids from a process material, comprising:
compressing the process material;
decompressing the process material;
mixing the process material; and
recompressing the process material, wherein the steps of compressing, decompressing, mixing, and recompressing are performed in a mechanical screw press.

2. The method of claim 1, wherein decompressing the process material and mixing the process material are performed simultaneously.

3. The method of claim 1, wherein decompressing the process material and mixing the process material are performed sequentially.

4. The method of claim 1, wherein the mechanical screw press comprises an assembly of worms and/or flights in a tunnel provided with a feed end and a discharge end.

5. The method of claim 4, wherein the worm assembly comprises at least one mixer region.

6. The method of claim 5, wherein the mixer region comprises an element adapted to disrupt a flow of the material.

7. The method of claim 5, wherein the mixer region comprises at least one of a multirecessed cog and a toothed disc.

8. The method of claim 5, wherein the mixer region further comprises a compressor region.

9. The method of claim 8, wherein the mixer region comprises a frusto conical member.

10. The method of claim 9, wherein the frusto conical member is smaller in diameter at a feed inlet end and greater in diameter at a discharge end.

11. The method of claim 10, wherein the compressor region is positioned at the discharge end.

12. The method of claim 10, wherein the compressor region is positioned at between 50 to 60% of the length of the worm assembly as measured from the feed inlet end.

13. The method of claim 8, wherein the mixer region is positioned approximately in the middle of the worm assembly.

14. The method of claim 8, wherein the compressor region is positioned at between 50 and 65% of the length of the worm assembly.

15. The method of claim 4, wherein the worm assembly comprises a plurality of mixer regions.

16. The method of claim 15, wherein the mixer regions are substantially evenly spaced along the length of the worm assembly.

17. The method of claim 16, wherein a first mixer region is positioned between 25 to 40% of the length of the worm assembly, and a second mixer region is positioned between 60 and 80% of the length of the worm assembly.

18. The method of claim 1, further comprising:
controlling flow of the process material using a temperature control element.

19. The method of claim 1, wherein the mechanical screw press comprises a choke.

20. A method of extracting liquids from a process material, comprising:
reducing a volume of the process material;
increasing the volume of the process material; and
reducing the volume of the process material, wherein the steps of reducing, increasing, and reducing are performed in a mechanical screw press.

21. The method of claim 20, wherein the mechanical screw press comprises an assembly of worms and/or flights in a tunnel provided with a feed end and a discharge end.

22. The method of claim 21, wherein the worm assembly comprises at least one mixer region.

23. The method of claim 22, wherein the mixer region comprises an element adapted to disrupt a flow of the material.

24. The method of claim 22, wherein the mixer region comprises at least one of a multirecessed cog and a toothed disc.

25. The method of claim 22, wherein the mixer region further comprises a compressor region.

26. The method of claim 25, wherein the mixer region comprises a frusto conical member.

27. The method of claim 26, wherein the frusto conical member is smaller in diameter at a feed inlet end and greater in diameter at a discharge end.

28. The method of claim 27, wherein the compressor region is positioned at the discharge end.

29. The method of claim 27, wherein the compressor region is positioned at between 50 to 60% of the length of the worm assembly as measured from the feed inlet end.

30. The method of claim 25, wherein the mixer region is positioned approximately in the middle of the worm assembly.

31. The method of claim 25, wherein the compressor region is positioned at between 50 and 65% of the length of the worm assembly.

32. The method of claim 21, wherein the worm assembly comprises a plurality of mixer regions.

33. The method of claim 32, wherein the mixer regions are substantially evenly spaced along the length of the worm assembly.

34. The method of claim 33, wherein a first mixer region is positioned between 25 to 40% of the length of the worm assembly, and a second mixer region is positioned between 60 and 80% of the length of the worm assembly.

35. The method of claim 20, further comprising:
controlling flow of the process material using a temperature control element.

36. The method of claim 20, wherein the mechanical screw press comprises a choke.

37. A mechanical screw press, comprising:
a worm assembly that is adapted to extract liquids from a process material by compressing, decompressing, mixing; and recompressing the process material.

38. The mechanical screw press of claim 37, wherein the worm assembly is disposed in a tunnel provided with a feed end and a discharge end.

39. The mechanical screw press of claim 38, wherein the worm assembly comprises at least one mixer region.

40. The mechanical screw press of claim 39, wherein the mixer region comprises an element adapted to disrupt a flow of the material.

41. The mechanical screw press of claim 39, wherein the mixer region comprises at least one of a multirecessed cog and a toothed disc.

42. The mechanical screw press of claim 39, wherein the mixer region further comprises a compressor region.

43. The mechanical screw press of claim 42, wherein the mixer region comprises a frusto conical member.

44. The mechanical screw press of claim 43, wherein the frusto conical member is smaller in diameter at a feed inlet end and greater in diameter at a discharge end.

45. The mechanical screw press of claim 44, wherein the compressor region is positioned at the discharge end.

46. The mechanical screw press of claim 44, wherein the compressor region is positioned at between 50 to 60% of the length of the worm assembly as measured from the feed inlet end.

47. The mechanical screw press of claim 42, wherein the mixer region is positioned approximately in the middle of the worm assembly.

48. The mechanical screw press of claim 42, wherein the compressor region is positioned at between 50 and 65% of the length of the worm assembly.

49. The mechanical screw press of claim 38, wherein the worm assembly comprises a plurality of mixer regions.

50. The mechanical screw press of claim 49, wherein the mixer regions are substantially evenly spaced along the length of the worm assembly.

51. The mechanical screw press of claim 50, wherein a first mixer region is positioned between 25 to 40% of the length of the worm assembly, and a second mixer region is positioned between 60 and 80% of the length of the worm assembly.

52. The mechanical screw press of claim 37, further comprising:
a temperature control element that is configured to control a flow of the process material.

53. The mechanical screw press of claim 37, wherein the mechanical screw press further comprises a choke.

54. A mechanical screw press, comprising:
a worm assembly that is adapted to extract liquids from a process material by reducing a volume of the process material, increasing the volume of the process material, and reducing the volume of the process material.

55. The mechanical screw press of claim 54, wherein the worm assembly is disposed in a tunnel provided with a feed end and a discharge end.

56. The mechanical screw press of claim 55, wherein the worm assembly comprises at least one mixer region.

57. The mechanical screw press of claim 56, wherein the mixer region comprises an element adapted to disrupt a flow of the material.

58. The mechanical screw press of claim 56, wherein the mixer region comprises at least one of a multirecessed cog and a toothed disc.

59. The mechanical screw press of claim 56, wherein the mixer region further comprises a compressor region.

60. The mechanical screw press of claim 59, wherein the mixer region comprises a frusto conical member.

61. The mechanical screw press of claim 60, wherein the frusto conical member is smaller in diameter at a feed inlet end and greater in diameter at a discharge end.

62. The mechanical screw press of claim 61, wherein the compressor region is positioned at the discharge end.

63. The mechanical screw press of claim 61, wherein the compressor region is positioned at between 50 to 60% of the length of the worm assembly as measured from the feed inlet end.

64. The mechanical screw press of claim 59, wherein the mixer region is positioned approximately in the middle of the worm assembly.

65. The mechanical screw press of claim 59, wherein the compressor region is positioned at between 50 and 65% of the length of the worm assembly.

66. The mechanical screw press of claim 55, wherein the worm assembly comprises a plurality of mixer regions.

67. The mechanical screw press of claim 66, wherein the mixer regions are substantially evenly spaced along the length of the worm assembly.

68. The mechanical screw press of claim 67, wherein a first mixer region is positioned between 25 to 40% of the length of the worm assembly, and a second mixer region is positioned between 60 and 80% of the length of the worm assembly.

69. The mechanical screw press of claim 54, further comprising:
a temperature control element that is configured to control a flow of the process material.

70. The mechanical screw press of claim 54, wherein the mechanical screw press further comprises a choke.
